(19) United States
(12) Patent Application Publication
(10) Pub. No.: US 2024/0294811 A1
(43) Pub. Date: Sep. 5, 2024

(54) WOOD BOARDS

(71) Applicant: KNAUF INSULATION SPRL, Vise (BE)

(72) Inventors: Richard HAND, St. Helens - Merseyside (GB); James LAING, St. Helens - Merseyside (GB)

(21) Appl. No.: 18/662,942

(22) Filed: May 13, 2024

Related U.S. Application Data
(63) Continuation-in-part of application No. 17/042,104, filed on Sep. 26, 2020.

(30) Foreign Application Priority Data
Mar. 27, 2018 (GB) 1804906.4

(51) Int. Cl. C09J 11/06; B27N 3/00; B27N 3/02; C09J 5/06

(52) U.S. Cl. CPC C09J 11/06; B27N 3/002; C09J 5/06; B27N 3/02

(57) ABSTRACT

A method of manufacturing a wood board, comprising:
applying a binder composition, notably in the form of an aqueous solution, to loose wood matter to provide resinated loose wood matter, wherein the binder composition consists of a binder composition prepared by combining reactants comprising at least 50% by dry weight reducing sugar reactant(s) and at least 5% by dry weight nitrogen-containing reactant(s); and
arranging the resinated wood matter as a sheet of loosely arranged resinated wood matter; and
subjecting the sheet of loosely arranged resinated wood matter to heat and pressure to cure the binder composition and to form the wood board from the sheet of loosely arranged resinated wood;
wherein the nitrogen-containing reactant(s) comprise TPTA triprimary triamine(s), notably wherein the nitrogen-containing reactant(s) comprise at least 5% by dry weight of TPTA triprimary triamine(s).

The present invention relates to wood boards and a method for their production. The present invention provides binder compositions with properties including excellent curing rates, bond strength, parting strength, tensile strength and low swelling properties, ease of handling and good storage stability.

In accordance with one aspect as defined in claim 1, the present invention provides a method of manufacturing a wood board, comprising:
applying a binder composition, notably in the form of an aqueous solution, to loose wood matter to provide resinated loose wood matter, wherein the binder composition consists of a binder composition prepared by combining reactants comprising at least 50% by dry weight reducing sugar reactant(s) and at least 5% by dry weight nitrogen-containing reactant(s); and
arranging the resinated wood matter as a sheet of loosely arranged resinated wood matter; and
subjecting the sheet of loosely arranged resinated wood matter to heat and pressure to cure the binder composition and to form the wood board from the sheet of loosely arranged resinated wood;
wherein the nitrogen-containing reactant(s) comprise TPTA triprimary triamine(s), notably wherein the nitrogen-containing reactant(s) comprise at least 5% by dry weight of TPTA triprimary triamine(s).

The dependent claims define preferred or alternative embodiments.

As used herein, the term “TPTA triprimary triamine(s)” means triprimary triamine(s) selected from:
triprimary triamine(s) having spacer groups between each of the three primary amines which consist of carbon chains;
triprimary triamine(s) having spacer groups between each of the three primary amines wherein each spacer group has a spacer length which is less than or equal to 12 polyvalent atoms; and
triprimary triamine(s) having a total number of polyvalent atoms which is less than or equal to 23. In one preferred embodiment the TPTA triprimary triamine(s) comprise, and more preferably consist of, triprimary triamine(s) having spacer groups between each of the three primary amines which consist of carbon chains. In another preferred embodiment the TPTA triprimary triamine(s) comprise, and more preferably consist of, triprimary triamine(s) having spacer groups between each of the three primary amines wherein each spacer group has a spacer length which is less than or equal to 12 polyvalent atoms. In a further preferred embodiment the TPTA triprimary triamine(s) comprise, and more preferably consist of, triprimary triamine(s) having a total number of polyvalent atoms which is less than or equal to 23.

The method may be used for the manufacture of engineered wood, composite wood, man-made wood, or manufactured board notably manufactured by binding strands, particles, fibers, plies veneers or layers of wood, together with a binder, notably an organic binder. The method is particularly suitable for the manufacture of a wood particle board or resin bonded particle board, comprising or consisting of wood particles held together by a binder, notably an organic binder. In this case, the loose wood matter comprises, consists essentially of or consists of wood particles. The particle board may be a P1, P2, P3, P4, P5, P6 or P7 particle board as described and/or defined in EN 312:2003 (the contents of which is hereby incorporated by reference). The wood board may be: an oriented strand board (OSB), notably an OSB/1, OSB/2, OSB/3 or OSB/4 oriented strand board as described in and/or meeting the requirements of EN 300:2006 (the contents of which is hereby incorporated by reference). The wood board may be plywood, notably a wood based panel consisting of an assembly of layers glued together with the direction of the grain in adjacent layers being offset, notably offset at right angles; it may be plywood as described in and/or meeting the requirements of ISO 12465:2007 or EN 313-2:2000 or EN 313-1:1996 or EN 636:2003 (the contents of which is hereby incorporated by reference). The wood board may be a fiberboard, notably a hardboard (HB), a medium board (MBL or MBH), a softboard (SB) or a medium density fiber board (MDF), notably as described in and/or meeting the requirements of EN 622-1:2003 (the contents of which is hereby incorporated by reference). The wood board may be a medium density fiberboard MDF, notably a MDF.H, MDF.LA, MDF.HLS, L-MDF, L.MDF.H, UL1-MDF, UL2-MDF, or MDF.RWH, notably as described in and/or meeting the requirements of EN 622-5:2009 (the contents of which is hereby incorporated by reference). The wood board may be provided with a facing, for example a veneer or a melamine layer, for example to improve its visual appearance and/or durability of its surface(s).

In accordance with another aspect, the present invention provides a wood board, manufactured by a method comprising:
applying a binder composition, notably in the form of an aqueous solution, to loose wood matter to provide resinated loose wood matter, wherein the binder composition consists of a binder composition prepared by combining reactants comprising at least 50% by dry weight reducing sugar reactant(s) and at least 5% by dry weight nitrogen-containing reactant(s); and
arranging the resinated wood matter as a sheet of loosely arranged resinated wood matter; and
subjecting the sheet of loosely arranged resinated wood matter to heat and pressure to cure the binder composition and to form the wood board from the sheet of loosely arranged resinated wood;
wherein the nitrogen-containing reactant(s) comprise TPTA triprimary triamine(s), notably wherein the nitrogen-containing reactant(s) comprise at least 5% by dry weight of TPTA triprimary triamine(s).

According to a further aspect, the present invention provides a method of manufacturing a wood particle board comprising;
applying a binder composition in the form of an aqueous solution to wood particles to provide resinated wood particles, wherein the binder composition consists of a binder composition prepared by combining reactants consisting of between 60% and 95% by dry weight reducing sugar reactant(s) and between 5% and 40% by dry weight nitrogen-containing reactant(s); and
   forming the resinated wood particles into a resinated mat of loosely arranged resinated wood particles; and
   subjecting the resinated mat to heat and pressure to cure the binder composition and to form the wood particle board;
   wherein the nitrogen-containing reactant(s) comprise at least 95 wt % of triprimary triamine(s) having spacer groups between each of the three primary amines which consist of carbon chains.

Any feature described herein in relation to a particular aspect of the invention may be used in relation to any other aspect of the invention.

The term “binder composition” as used herein means all ingredients applied to the wood matter and/or present on the wood matter, notably prior to curing, (other than the wood matter itself and any moisture in the wood matter), including reactants, solvents (including water) and additives. The term “dry weight of the binder composition” as used herein means the weight of all components of the binder composition other than any water that is present (whether in the form of liquid water or in the form of water of crystallization). The reactants may make up ≥80%, ≥90% or ≥95% and/or ≤99% or ≤98% by dry weight of the binder composition. In some embodiments, the binder composition includes one or more fillers, for example for the manufacture of plywood; the filler(s) may make up ≥15%, ≥20% or ≥25% and/or ≤55%, ≤50% or ≤40% by dry weight of the binder composition and/or of the cured binder. Particularly where the binder composition comprises fillers, the reactants may make up ≥50%, ≥60% or ≥65% and/or ≤90%, ≤85% or ≤80% by dry weight of the binder composition.

The binder composition applied to the wood matter comprises reactants which cross-link when cured to form a cured binder which holds the wood matter of the wood board together. The binder composition comprises reactants that will preferably form a thermoset resin upon curing.

The binder composition is preferably free of, or comprises no more than 2 wt %, no more than 5 wt % or no more than 10 wt % of urea formaldehyde (UF), melamine urea formaldehyde (MUF) and/or phenol formaldehyde.

The binder composition is preferably a “no added formaldehyde binder” that is to say that none of ingredients used to form the binder composition comprise formaldehyde. It may be “substantially formaldehyde free”, that is to say that it liberates less than 5 ppm formaldehyde as a result of drying and/or curing (or appropriate tests simulating drying and/or curing); more preferably it is “formaldehyde free”, that is to say that it liberates less than 1 ppm formaldehyde in such conditions.

The term “a sheet of loosely arranged resinated wood matter” as used herein means that the resinated wood matter is assembled together with sufficient integrity for the sheet to be processed along a production line but without the resinated wood matter being permanently joined together in a way that is achieved by fully cross-linking the binder composition. Prior to curing, the binder composition preferably provides a stickiness or tackiness which holds that loosely arranged wood matter together. For example, in the case of wood particle board, the sheet of loosely arranged wood matter preferably has sufficient cohesion to be retained in the form or a sheet or mat, notably when passing along a production line, and/or being transferred between conveyor belts. In the case of plywood, the individual plies in a sheet of loosely arranged resinated wood matter preferably have sufficient cohesion to avoid relative movement between the plies, notably when passing along a production line, and/or being transferred between conveyor belts.

Preferably, the binder composition is a reducing sugar based binder composition, that is to say that at least 50 wt % of the reactants comprise reducing sugar(s) and/or reaction products of reducing sugar(s). The binder composition may be prepared by combining reactants comprising, consisting essentially of or consisting of the reducing sugar reactant(s) and the nitrogen-containing reactant(s). In the form in which it is applied to the wood matter the binder composition may comprise (a) the reducing sugar reactant(s) and the nitrogen-containing reactant(s) and/or (b) curable reaction product(s) of the reducing sugar reactant(s) and the nitrogen-containing reactant(s).

As used herein, the term “consist or consisting essentially of” is intended to limit the scope of a statement or claim to the specified materials or steps and those that do not materially affect the basic and novel characteristic(s) of the invention.

The reducing sugar reactant(s) may comprise: a monosaccharide, a monosaccharide in its aldose or ketose form, a disaccharide, a polysaccharide, a triose, a tetrose, a pentose, xylose, a hexose, dextrose, fructose, a heptose, or mixtures thereof. The reducing sugar reactant(s) may be yielded in situ by carbohydrate reactant(s), notably carbohydrate reactant(s) having a dextrose equivalent of at least about 50, at least about 60, at least about 70, at least about 80 or at least about 90, notably carbohydrate reactant(s) selected from the group consisting of molasses, starch, starch hydrolysate, cellulose hydrolysates, and mixtures thereof. The reducing sugar reactant(s) may comprise or consist of a combination of dextrose and fructose, for example in which the combination of dextrose and fructose makes up at least 80 wt % of the reducing sugar reactant(s) and/or in which the dextrose makes up at least 40% wt % of the reducing sugar reactant(s) and/or in which the fructose makes up at least 40% wt % of the reducing sugar reactant(s); the reducing sugar reactant(s) may comprise or consist of high fructose corn syrup (HFCS). The reducing sugar reactant(s) may comprise or consist of reducing sugar reactant(s) yielded in situ by sucrose. The reducing sugar reactant(s) may comprise reducing sugar reactant(s) selected from the group consisting of xylose, arabinose dextrose, mannose, fructose and combinations thereof, for example making up at least 80 wt % of the reducing sugar reactant(s).

As used herein, the term “nitrogen-containing reactant(s)” means one or more chemical compound which contain(s) at least one nitrogen atom and which is/are capable of reacting with the reducing sugar reactant(s); preferably the nitrogen-containing reactant(s) consist of Maillard reactant(s), that is to say reactant(s) which is/are capable of reacting with the reducing sugar reactant(s) as part of a Maillard reaction.

The nitrogen-containing reactant(s) comprise, and may consist essentially of or consist of, triprimary triamine(s) having spacer groups between each of the three primary amines which consist of carbon chains. The triprimary triamine(s) may be selected from the group consisting of triaminodecanes, triaminononanes, notably 4-(aminomethyl)-1,8-octanediamine, triaminooctanes, triaminoheptanes, notably 1,4,7-triaminoheptane, triaminohexanes, notably 1,3,6-triaminohexane, triaminopentanes, and including isomers and combination thereof.

As used herein the term “triprimary triamine(s)” means organic compound having three and only three amines, each of the three amines being primary amines (—NH₂). One, two or each of the primary amine(s) of the triprimary triamine(s) may be present in the form of a salt, e.g as an ammonium group (—NH₃⁺).

As used herein, the term “spacer group” in the terminology “the spacer group(s) separating each of the three primary amines” means a chain separating two primary amines. As used herein, the term “the spacer group(s) separating each primary amines in the molecule consists of carbon chains” means that the spacer group(s) consist only of carbon atoms bonded to hydrogen atoms or bonded to other carbon atoms. The triprimary triamine(s) having spacer groups between each of the three primary amines which consist of carbon chains thus consist of the three primary amines and carbon and hydrogen atoms. For example, when the spacer group(s) separating each primary amine in the molecule consists of carbon chains, no heteroatoms are present in the spacer groups.

The spacer group(s) may be selected from the group consisting of alkanediyls, heteroalkanediyls, alkenediyls, heteroalkenediyls, alkynediyls, heteroalkynediyls, linear alkanediyls, linear heteroalkanediyls, linear alkenediyls, linear heteroalkenediyls, linear alkynediyls, linear heteroalkynediyls, cycloalkanediyls, cycloheteroalkanediyls, cycloalkenediyls, cycloheteroalkenediyls, cycloalkynediyls and cycloheteroalkynediyls, each of which may be branched or unbranched. The spacer group(s) may be selected from the group consisting of alkanediyls, alkenediyls, alkynediyls, linear alkanediyls, linear alkenediyls, linear alkynediyls, cycloalkanediyls, cycloalkenediyls and cycloalkynediyls, each of which may be branched or unbranched. The spacer group may comprise or may be devoid of halogen atoms. The spacer groups may comprise or be devoid of aromatic groups. As used herein: the term “alkanediyl” means a saturated chain of carbon atoms ie without carbon-carbon double or triple bonds; the term “alkenediyl” means a chain of carbon atoms that comprises at least one carbon-carbon double bond; the term “alkynediyl” means a chain of carbon atoms that comprises at least one carbon-carbon triple bond; the term “cyclo” in relation to cycloalkanediyl, cycloalkenediyl and cycloalkynediyl indicates that at least a portion of the chain is cyclic and also includes polycyclic structures; and the term “linear” in relation to alkanediyls, alkenediyls and alkynediyls indicates an absence of a cyclic portion in the chain. As used herein, the term “hetero” in relation to heteroalkanediyls, heteroalkenediyls, heteroalkynediyls, linear heteroalkanediyls, linear heteroalkenediyls, linear heteroalkynediyls, cycloheteroalkanediyls, cycloheteroalkenediyls, and cycloheteroalkynediyls means that the chain comprise at least one polyvalent heteroatom. As used herein, the term heteroatom is any atom that is not carbon or hydrogen. As used herein, the term polyvalent atom means an atom that is able to be covalently bonded to at least 2 other atoms. The polyvalent heteroatom may be oxygen; it may be silicon; it may be sulfur or phosphorus. One, two or preferably each of the spacer groups may have a total number of polyvalent atoms, or a total number of carbon atoms which is ≥3, >4 or ≥5 and/or ≤12, ≤10 or ≤9. One, two or preferably each of the spacer groups may have a spacer length which is ≥3, ≥4 or ≥5 and/or ≤12, ≤10 or ≤9. As used herein, the term “spacer length” in relation to a spacer group separating two primary amines means the number of polyvalent atoms which form the shortest chain of covalently bonded atoms between the two primary amines. Each of the spacer groups between the three primary amines of the TPTA triprimary triamine(s) may: consist of an alkanediyl; and/or be linear; and/or be unbranched; and/or have a number of carbon atoms which is ≥3 or ≥4 and/or ≤9 or ≤8; and or have a spacer length which is ≥3 or ≥4 and/or ≤9 or ≤8. The total number of the polyvalent atoms of the TPTA triprimary triamine(s) may be ≥9, ≥11 or ≥12 and/or ≤23, ≤21, ≤19 or ≤17.

The nitrogen-containing reactant(s) may comprise reactant(s) selected from the group consisting of: inorganic amines, organic amines, organic amines comprising at least one primary amine, salts of an organic amine comprising at least one primary amine, polyamines, polyprimary polyamines and combinations thereof, any of which may be substituted or unsubstituted. The nitrogen-containing reactant(s) may comprise NH₃, NH₃ may be used as such (e.g. in form of an aqueous solution), or as an inorganic or organic ammonium salt, for example ammonium sulfate, ammonium phosphate, e.g. diammonium phosphate or ammonium citrate, e.g. triammonium citrate, or as a source of NH₃, e.g. urea. In one preferred embodiment, the nitrogen-containing reactant(s) comprise ammonium sulfate. In another preferred embodiment, the nitrogen-containing reactant(s) comprise ammonium citrate. As used herein, the term “polyamine” means any organic compound having two or more amine groups and the term “polyprimary polyamine” means an organic compound having two or more primary amines (—NH₂). As used herein the term “substituted” means the replacement of one or more hydrogen atoms with other functional groups. Such other functional groups may include hydroxyl, halo, thiol, alkyl, haloalkyl, heteroalkyl, aryl, arylalkyl, arylheteroalkyl, nitro, sulfonic acids and derivatives thereof, carboxylic acids and derivatives thereof.

The polyprimary polyamine may be a diamine, triamine, tetramine, or pentamine. As used herein the term “diamine” means organic compound having two (and only two) amines, “triamine” means organic compound having three (and only three) amines, “tetramine” means organic compound having four (and only four) amines and “pentamine” means organic compound having five (and only five) amines. For example, the polyprimary amine may be: a triamine selected from diethylenetriamine (which is a diprimary triamine, i.e. diethylenetriamine has three amines, two of them being primary amines) or bis(hexamethylene)triamine; a tetramine, notably triethylenetetramine; or a pentamine, notably tetraethylenepentamine. The polyprimary polyamine may comprise diprimary diamine, notably 1,6-diaminohexane (hexamethylenediamine, HMDA) or 1,5-diamino-2-methylpentane (2-methyl-pentamethylenediamine).

The binder composition may comprise, consist essentially of or consist of a binder composition prepared by combining reactants wherein:
the reducing sugar reactant(s) make up:
   ≥50%, ≥60%, ≥70% by dry weight of the reactant(s), and/or
   ≤97%, ≤95%, ≤90%, ≤85% by dry weight of the reactant(s), and/or
the nitrogen-containing reactant(s) make up:
   ≥3%, ≥5%, ≥7%, ≥10%, ≥15% by dry weight of the reactant(s), and/or
   ≤50%, ≤40%, ≤30%, ≤25% by dry weight of the reactant(s).
The binder composition may comprise, consist essentially of or consist of a binder composition prepared by combining reactants consisting of between 60% and 95% by dry weight reducing sugar reactant(s) and between 5% and 40% by dry weight nitrogen-containing reactant(s). The TPTA triprimary triamine(s) may make up:
   ≥3%, ≥5%, ≥7%, ≥10%, ≥15%, and/or
   ≤40%, ≤35%, ≤30%, ≤25%
by dry weight of the reactants of the binder composition.
The TPTA triprimary triamine(s) may make up:
   ≥5%, ≥10%, ≥15%, ≥20%, ≥30%, ≥40%, ≥50%, ≥60%, ≥65%; and/or
   ≤95%, ≤90%, ≤85%, ≤80%, ≤70%, ≤60%, ≤50%, ≤45%, ≤30% by dry weight of the nitrogen-containing reactants.
The TPTA triprimary triamine(s) may make up: ≥90% and ≤99%; or ≥80% and ≤90%; or ≥60% and ≤80%; by dry weight of the nitrogen-containing reactants. Particularly in the aforementioned cases, the remaining nitrogen-containing reactants may comprise amines and/or nitriles.
When the nitrogen-containing reactant(s) comprise nitrogen-containing reactant(s) other than TPTA triprimary triamine(s), the and notably each nitrogen-containing reactant other than TPTA triprimary triamine(s), may make up:
   ≥3%, ≥5%, ≥7%, ≥10%, ≥15%, and/or
   ≤40%, ≤35%, ≤30%, ≤25%
by dry weight of the reactants of the binder composition.
The and notably each nitrogen-containing reactant other than TPTA triprimary triamine(s), may make up:
   ≥5%, ≥10%, ≥15%, ≥20%, ≥30%, ≥40%, ≥50%, ≥60%, ≥65%; and/or
   ≤95%, ≤90%, ≤85%, ≤80%, ≤70%, ≤60%, ≤50%, ≤45%, ≤30%
by dry weight of the nitrogen-containing reactants.

The ratio of carbonyl groups in the reducing sugar reactant(s) to reactive amino groups in the nitrogen-containing reactant(s) may be in the range of 5:1 to 1:2. For example, the ratio of carbonyl groups to reactive amino groups may be in the range of 5:1 to 1:1.8, 5:1 to 1:1.5, 5:1 to 1:1.2, 5:1 to 1:1, 5:1 to 1:0.8 and 5:1 to 1:0.5. Further examples include ratios such as 4:1 to 1:2, 3.5:1 to 1:2, 3:1 to 1:2, 2.5:1 to 1:2, 2:1 to 1:2 and 1.5:1 to 1:2. As used herein, the term “reactive amino group” means any amino group in the nitrogen-containing reactant(s) which is capable of reacting with the reducing sugar reactant(s). Specifically, examples of such reactive amino groups comprise primary and secondary amine(s).

The nitrogen-containing reactant(s) and the reducing sugar reactant(s) are preferably Maillard reactant(s). The nitrogen-containing reactant(s) and the reducing sugar reactant(s) (or their reaction product(s)) preferably react to form Maillard reaction products, notably melanoidins when cured. Curing of the binder composition may comprise or consist essentially of Maillard reaction(s). Preferably, the cured binder consists essentially of Maillard reaction products. The cured binder composition may comprise melanoidin-containing and/or nitrogenous-containing polymer(s); it is preferably a thermoset binder and is preferably substantially water insoluble.

The binder composition and/or the cured binder may comprise ester and/or polyester compounds.

The binder composition may be prepared by combining all the reducing sugar reactant(s) and all the nitrogen-containing reactant(s) in a single preparation step, for example by dissolving the reducing sugar reactant(s) in water and then adding the nitrogen-containing reactant(s). The term “single preparation step” is used herein to differentiate from a “multiple preparation step” preparation in which a first portion of reactants are combined and stored and/or allowed to react for a pre-determined time before addition of further reactants.

Alternatively, the binder composition may be prepared by:
combining reducing sugar reactant(s), notably all of the reducing sugar reactant(s), with a first portion of the nitrogen-containing reactant(s) to provide an intermediate binder composition,
storing the intermediate binder composition; and
combining the intermediate binder composition with a second portion of the nitrogen-containing reactant(s) to provide the binder composition.

The intermediate binder composition may comprise, consist essentially of or consist of reaction products of the reducing sugar reactant(s), with a first portion of the nitrogen-containing reactant(s). The reactants may be heated to provide the intermediate binder composition; the intermediate binder composition may be subsequently cooled.

The first and second portions of nitrogen-containing reactant(s) may be the same nitrogen-containing reactant(s) or, alternatively they may be different nitrogen-containing reactant(s). Only one of the first and second portion of nitrogen-containing reactant(s), or alternatively each of the first and second portion of nitrogen-containing reactant(s), may comprise, consist essentially of or consist of TPTA triprimary triamine(s).

As used herein “storing the intermediate binder composition” means that the intermediate binder composition is stored or shipped for a prolonged time, notably without crystallization of the reducing sugar reactant(s) or gelling which would render the binder composition unusable. The intermediate binder composition may be stored for a period of at least 30 min, at least 1 h, at least 4 h, at least 12 h, at least 24 h, at least 96 h, at least 1 week, at least 2 weeks, or at least 4 weeks.

The binder composition may comprise one or more additives, for example one or more additives selected from waxes, dyes, release agents, formaldehyde scavengers (for example urea, tannins, quebracho extract, ammonium phosphate, bisulfite), water repellent agent, silanes, silicones, lignins, lignosulphonates and non-carbohydrate polyhydroxy component selected from glycerol, polyethylene glycol, polypropylene glycol, trimethylolpropane, pentaerythritol, polyvinyl alcohol, partially hydrolyzed polyvinyl acetate, fully hydrolyzed polyvinyl acetate, or mixtures thereof. Such additives are generally not reactants of the binder composition, that is to say they do not cross-link with the reducing sugar and/or the nitrogen containing reactant(s) (or reaction products thereof) as part of the curing of the binder composition.

The binder composition may be applied to the wood matter in the form of a liquid, notably in the form of an aqueous composition, for example comprising an aqueous solution or dispersion, notably in which the dry weight of the aqueous binder composition makes up: ≥40 wt %, ≥45 wt %, ≥50 wt %, ≥55 wt % or ≥60 wt % and/or ≤95 wt %, ≤90 wt %, ≤85 wt % or ≤80 wt % of the total weight of the aqueous binder composition. Alternatively, the binder composition may be applied to the wood matter in the form of a solid, for example as a powder or as particles. The binder composition may be applied by being sprayed; this is particularly suitable for manufacturing wood particle board. The binder composition may be applied to wood particles by passing the wood particles through a spray of the binder composition or by spraying the binder composition over the wood particles, for example whilst the wood particles are being mixed. Preferably, the wood particles are mixed subsequent to application of the binder composition, for example by tumbling, notably in a mixer or bunker. The binder composition may be applied by being spread, for example as a continuous layer or as a discontinuous layer, for example as lines of binder; this is particularly suitable for the manufacture of plywood.

The wood boards, notably once cured, may comprise at least 70%, at least 80%, at least 90% or at least 95% by weight of wood matter.

The binder loading, that is to say the amount of binder applied to the loose wood matter and calculated in terms of the dry weight of the binder composition applied to the loose wood matter with respect to the combined weight of i) the dry weight of the loose wood matter and ii) the dry weight of the binder composition applied to the wood matter may be ≥1.5%, ≥2%, ≥2.5%, ≥3%, ≥5%, ≥7% and/or ≤15%, ≤13%, ≤11%.

The thickness of the wood board may be ≥5 mm, ≥8 mm, ≥10 mm, or ≥15 mm and/or ≤100 mm, ≤80 mm, ≤60 mm, ≤50 mm, ≤45 mm or ≤25 mm. Preferred thicknesses are in the range of 10 to 45 mm or 16 to 22 mm. The length of the wood board may be ≥1.5 m, ≥2 m, ≥2.5 m or ≥3 m and/or ≤8 m, ≤6 m or ≤5 m. The width of the wood board may be ≥1 m, ≥1.2 m, ≥1.5m or ≥1.8 m and/or ≤4 m, ≤3 m or ≤3.5 m. The wood boards may have edges which are trimmed and/or cut and/or machined. The wood boards may be piled up and provided as a package comprising a plurality of boards arranged and/or bound together, for example to facilitate transport; the package may comprise an enveloping film, for example of a plastics material.

Subjecting the sheet of loosely arranged resinated wood matter to heat and pressure to cure the binder composition and to form the wood board from the sheet of loosely arranged resinated wood may comprise pressing the sheet of loosely arranged resinated wood matter between heated belts or plates, for example in a hot press, for example at a pressure which is ≥20 bar, ≥25 bar or ≥30 bar and/or ≤80 bar, ≤75 bar, ≤70 bar or ≤65 bar to obtain a cured wood particle board. The temperature or the heated belts or plates may be ≥100° C., ≥110° C. or ≥120° C. and/or ≤280° C., ≤260° C., ≤240° C., ≤220° C. or ≤200° C. The press factor, that is to say the time during which the sheet of loosely arranged resinated wood matter is subjected to heat and pressure in a press to cure the binder composition and to form the wood board and expressed in seconds per mm of pressed thickness of the wood boards may be ≥2 s/mm, ≥3 s/mm, ≥4 s/mm or ≥5 s/mm and/or ≤10 s/mm, ≤9 s/mm, ≤8 s/mm or ≤7 s/mm.

During the pressing and/or heating and/or curing of the wood board, the internal temperature of the wood board, notably the temperature at the center of the board in its thickness direction, may be raised to a temperature which is:
a) ≥90° C., ≥100° C., ≥110° C., ≥115° C., ≥120° C., ≥130° C. or ≥140° C., and/or
b) ≤200° C., ≤180° C., ≤170° C. or ≤160° C.
   The temperature of the surface layer(s) of the wood board may be raised to a temperature which is:
a) ≥120° C., ≥130° C. or ≥140° C., and/or
b) ≤260° C., ≤220° C., or ≤200° C.

The wood matter may notably be wood particles and the wood board may be a particle board. The wood particles may comprise wood chips, wood flakes, wood strands sawmill shavings, saw dust, wood fibers and mixtures thereof. The wood particles may be selected from virgin wood, reclaimed wood or combinations thereof; the wood particles may be selected from birch, beech, alder, pine, spruce tropical wood and wood mixtures. Preferably, the wood particles contacted with the binder composition have a moisture content which is ≤8%, ≤6% or ≤5% by weight. The wood particles may be dried prior to being contacted with the binder composition; the dried wood particles may have a moisture content which is ≥1%, ≥1.5% or ≥2% and ≤5%, ≤4% or ≤3.5% by weight.

The wood board may be a multi-layer wood particle board comprising at least one core layer arranged between two surface layers; it may be a three layer wood particle board. Where the wood board is a multi-layer wood particle board, the binder composition may be:
a surface layer binder composition, that is to say a binder composition applied to surface layer wood particles; and/or
a core layer binder composition, that is to say a binder composition applied to core layer wood particles.
   The binder composition may be used as the surface layer binder composition and as the core layer binder composition; in this case:
the reactants of the core layer binder composition may comprise a greater proportion of nitrogen-containing reactant(s), preferably a greater proportion of TPTA triprimary triamine(s), than the reactants of the surface layer binder composition; and/or
the binder loading of the surface layer may be higher that the binder loading of the core layer, for example with a core layer binder loading which is ≥1.5 wt %, ≥2 wt % and ≤6 wt %, ≤5 wt % or ≤4 wt % and a surface layer binder loading which is ≥6 wt % ≥7 wt % or ≥8 wt % and/or ≤15 wt %. The binder composition may be used only as the surface layer binder composition; in this case, a resin selected from phenol formaldehyde, urea formaldehyde, melamine-urea-formaldehyde, an isocyanate, such as methylene diphenyl diisocyanate, or a polyester may be used as the core layer binder composition.

Where the wood board is a wood particle board, its 24 h swelling, as measured in accordance with EN 317:1993 may be as shown in Table 1:

TABLE 1

Swelling in thickness, 24 h

| Thickness range (mm, nominal) | Preferred | More preferred |
|---|---|---|
| 3 to 4 | ≤23% | ≤13% |
| >4 to 6 | ≤19% | ≤12% |
| >6 to 13 | ≤16% | ≤11% |
| >13 to 20 | ≤15% | ≤10% |
| >20 to 25 | ≤15% | ≤10% |
| >25 to 32 | ≤15% | ≤10% |
| >32 to 40 | ≤14% | ≤9% |
| >40 | ≤14% | ≤9% |

Where the wood board is a wood particle board, its internal bond strength, as measured in accordance with EN 319:1993 may be as shown in Table 2:

TABLE 2

Internal bond (N/mm²)

| Thickness range (mm, nominal) | Preferred | More preferred |
|---|---|---|
| 3 to 4 | ≥0.45 | ≥0.50 |
| >4 to 6 | ≥0.45 | ≥0.50 |
| >6 to 13 | ≥0.40 | ≥0.45 |
| >13 to 20 | ≥0.35 | ≥0.45 |
| >20 to 25 | ≥0.30 | ≥0.40 |
| >25 to 32 | ≥0.25 | ≥0.35 |
| >32 to 40 | ≥0.20 | ≥0.30 |
| >40 | ≥0.20 | ≥0.25 |

Where the wood board is a wood particle board, its modulus of elasticity in bending, as measured in accordance with EN 310 may be as shown in Table 3:

TABLE 3

Modulus of elasticity in
bending (N/mm²)

| Thickness range (mm, nominal) | Preferred | More preferred |
|---|---|---|
| 3 to 4 | ≥1950 | ≥2550 |
| >4 to 6 | ≥2200 | ≥2550 |
| >6 to 13 | ≥2300 | ≥2550 |
| >13 to 20 | ≥2300 | ≥2400 |
| >20 to 25 | ≥2050 | ≥2150 |
| >25 to 32 | ≥1850 | ≥1900 |
| >32 to 40 | ≥1500 | ≥1700 |
| >40 | ≥1200 | ≥1550 |

Where the wood board is a wood particle board, its bending strength, as measured in accordance with EN 310 may be as shown in Table 4:

TABLE 4

Bending strength (N/mm²)

| Thickness range (mm, nominal) | Preferred | More preferred |
|---|---|---|
| 3 to 4 | ≥15 | ≥20 |
| >4 to 6 | ≥16 | ≥19 |
| >6 to 13 | ≥16 | ≥18 |
| >13 to 20 | ≥15 | ≥16 |
| >20 to 25 | ≥13 | ≥14 |
| >25 to 32 | ≥11 | ≥12 |
| >32 to 40 | ≥9 | ≥10 |
| >40 | ≥7 | ≥9 |

Methods of manufacturing wood board according to the present invention allow for cure speeds which are at least equivalent to and indeed faster than those obtained with comparable binder systems. Similarly, the dry tensile strength of glass veils manufactured with the binder compositions of the present invention is at least equivalent to and indeed in some cases improved when compared to that obtained with comparable binder systems. Surprisingly, the wet strength of glass veils manufactured with the binder compositions of the present invention is significantly improved with respect to that obtained with comparable binder systems. The wet strength provides an indication of the performance after aging and/or after weathering and is indicative of swelling performance for wood boards. This is unexpected as it is generally expected that the wet strength of a glass veil will be lower than but proportional to its dry strength. Without wishing to be being bound by theory, it is believed that the improved properties of the binder compositions of the present invention are due to the use of TPTA triprimary triamine(s) and particularly due to the spacer groups being carbon chains with an absence of heteroatoms within the spacer groups and/or due to the spatial geometry of the TPTA triprimary triamine(s) molecules.

Embodiments of the invention will now be described, by way of example only, with reference to the accompanying figures of which:

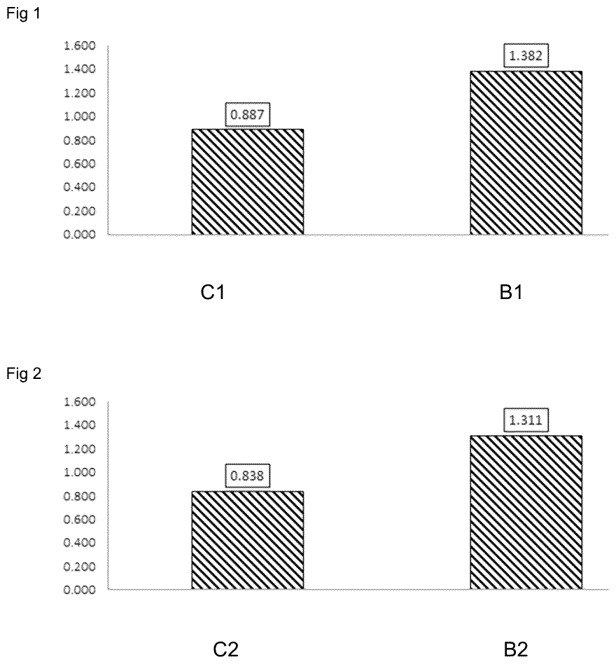

FIGS. 1 and 2 show surface soundness results;

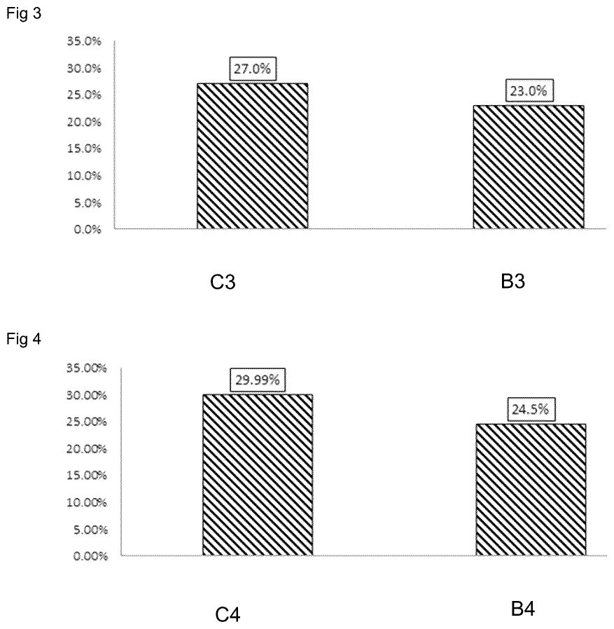

FIGS. 3 and 4 show 24 h water swelling results;

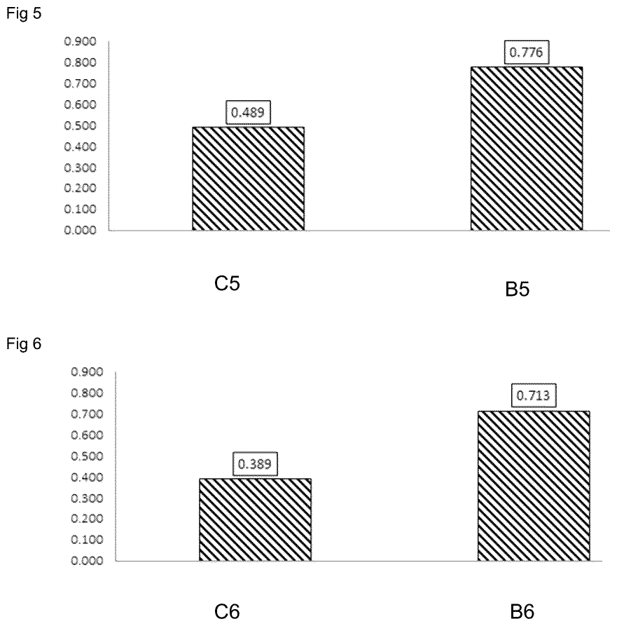

FIGS. 5 and 6 show internal bond strength results;

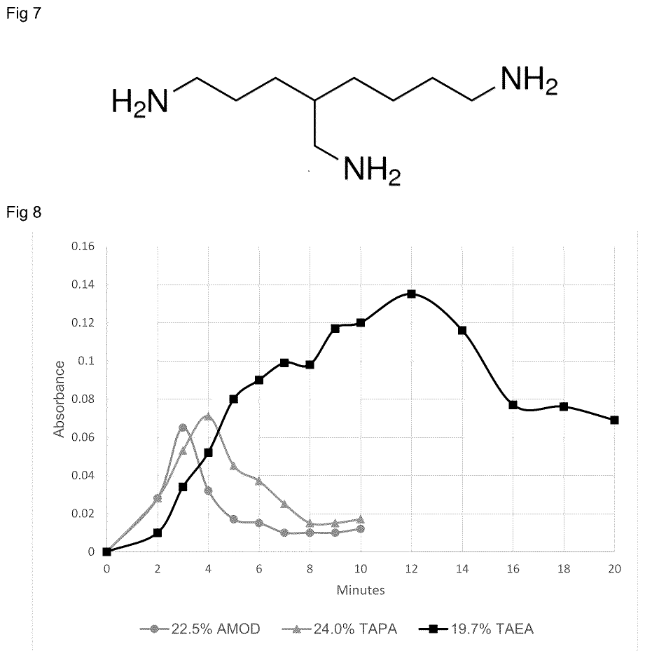

FIG. 7 shows 4-(aminomethyl)-1,8-octanediamine (“AMOD”);

FIG. 8 shows cure results of a laboratory cure test of triprimary polyamines;

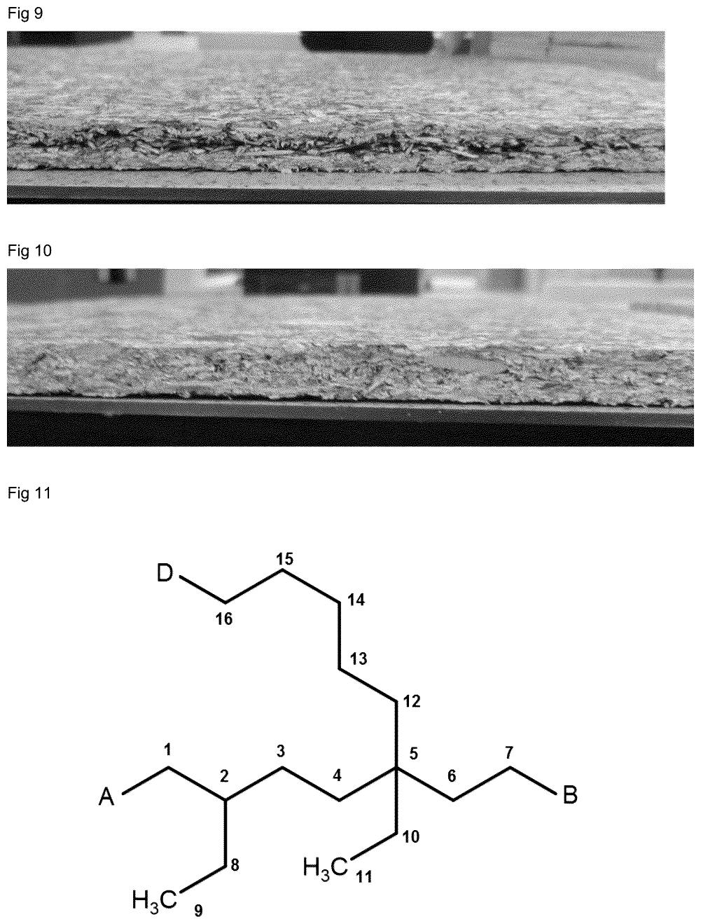

FIG. 9 shows a blow crack formed on a wood board made using TAEA as the nitrogen-containing reactant with a press time of 90s;

FIG. 10 shows a wood board made using AMOD as the nitrogen-containing reactant with a press time of 90s; and

FIG. 11 shows an example of TPTA triprimary triamine.

### EXAMPLE 1

### Wood Particles Boards

Wood particle boards are commonly manufactured using urea formaldehyde binders. The following compares:
Examples B1, B2, B3, B4, B5 and B6 which are laboratory manufactured three layer wood particle boards in accordance with the invention; with
Comparative examples C1, C2, C3, C4, C5 and C6 which are laboratory manufactured three layer wood particle boards manufactured using a common urea formaldehyde binder.

The laboratory manufactured particle boards described herein were manufactured contemporaneously in a way to enable comparison between them. Laboratory conditions and results are not necessarily directly comparable with results that would be obtained during industrial manufacture of particle boards. For example: results obtained using a binder loading of 8 wt % in the laboratory may be hoped to be achieved using a binder loading of 3-4 wt % during industrial manufacture; a press time of 7 s/mm in the laboratory may be required to simulate what could be hoped for using a press time of 4.5 s/mm during industrial manufacture; 24h water swelling of 30% in the laboratory may provide an indication that a 24 h water swelling of 15% could be hoped for during industrial manufacture. Similarly, the present laboratory results may not be directly comparable with other laboratory results for example which use different methods, conditions, wood particles or equipment.

For the measurements conducted:
surface soundness was tested in accordance with EN 311:2002. A circular groove (inner diameter of 35.7 mm) is cut 0.3 mm deep into the test sample. A steel pad is glued onto the board surface, on the cut surface portion. After the adhesive has hardened a tensile force is applied at constant speed so that failure occurs, preferably within the surface layer; the force at failure is recorded and expressed in Newtons per square millimeter.
swelling was measured in accordance with EN 317:1993.
internal bond strength (IB) was tested in accordance with EN 319:1993; this is intended to evaluate the tensile strength perpendicular to the plane of the test piece and expressed in N/mm².

Each of the examples B1, B2, B3, B4, B5 and B6 and comparative examples C1, C2, C3, C4, C5 and C6 was a three-layer particle board having:
a length and width of about 300×300 mm;
a pressed thickness of about 16 mm;
a density of about 650 kg/m³; and
a core:surface wood chip mass ratio 62:38;
   prepared by
spraying a binder composition on to oven dried wood particles having a residual moisture content of about 3.5 wt % and thoroughly mixing;
assembling the resinated wood particles into a resinated mat of loosely arranged resinated wood particles; and
pressing the mat of loosely arranged resinated wood particles between heated plates of a press (pressure 56 bar; target plate temperature 180° C.);
   to cure the binder composition and to form the wood particle board.

The binders and press factors are described below. The same core type particles were used for each core and the same surface type particles were used for each surface layer, with the average particle size of the surface type particles being smaller than that of the core type particles.

Comparative examples C1, C2, C3, C4, C5 and C6 were produced using a commonly used urea formaldehyde binder available from Dynea under reference 10F102 using:
a) for the core layer binder composition:
   a binder loading of 7.5 wt % on the wood particles;
   an ammonium nitrate catalyst with the binder at a solids ratio of 4.5:95.5 by weight catalyst: urea formaldehyde resin; and
b) for the surface layer binder composition:
   a binder loading of 10 wt % on the wood particles;
   an ammonium nitrate catalyst with the binder at a solids ratio of 0.5:99.5 by weight catalyst:urea formaldehyde resin.

Examples B1, B2, B3, B4, B5 and B6 were produced with the following binder compositions:
a) for the core layer binder composition:
   a binder composition prepared by combining reactants consisting of 69% by dry weight reducing sugar reactants and 31% by dry weight nitrogen-containing reactant where i) the reducing sugar reactants consisted of 50 wt % fructose and 50 wt % dextrose monohydrate; and the nitrogen-containing reactant consisted of 4-(aminomethyl)-1,8-octanediamine;
   a binder loading of 7.5 wt % on the wood particles; and
b) for the surface layer binder composition:
   a binder composition prepared by combining reactants consisting of 79.2% by dry weight reducing sugar reactants and 20.8% by dry weight nitrogen-containing reactant where i) the reducing sugar reactants consisted of 50 wt % fructose and 50 wt % dextrose monohydrate; and the nitrogen-containing reactant consisted of 4-(aminomethyl)-1,8-octanediamine;
   a binder loading of 8 wt % on the wood particles.

Boards B1 and C1 were each cured at a press factor of 10 s/mm. FIG. 1 shows a higher surface soundness for board B1 (about 1.4 N/mm²) compared with board C1 (about 0.9 N/mm²); Each of boards B2 and C2 was cured at a press factor of 8 s/mm. FIG. 2 shows a higher surface soundness for board B2 (about 1.3 N/mm²) compared with board C2 (about 0.8 N/mm²). It is notable that higher surface soundness of B1 and B2 was achieved with a binder loading of 8 wt % in the surface layer compared with a surface layer binder loading of 10 wt % for C1 and C2.

Boards B3 and C3 were each cured at a press factor of 10 s/mm. FIG. 3 shows a lower 24 h water swelling for board B3 (about 23%) compared with board C3 (about 27%). Each of boards B4 and C4 was cured at a press factor of 8 s/mm. FIG. 4 shows a lower 24 h water swelling for board B4 (about 25%) compared with board C4 (about 30%).

It is again notable that B3 and B4 show such improvement of 24 h water swelling compared to C3 and C4 despite the binder loading of the surface layer for C3 and C4 being 10 wt % and the binder loading of the surface layer of B3 and B4 being only of 8 wt %.

Boards B5 and C5 were each cured at a press factor of 10 s/mm. FIG. 5 shows a higher internal bond strength for board B5 (about 0.8 N/mm²) compared with board C5 (about 0.5 N/mm²). Each of boards B6 and C6 was cured at a press factor of 8 s/mm. FIG. 6 shows a higher internal bond strength for board B6 (about 0.7 N/mm²) compared with board C6 (about 0.4 N/mm²).

### EXAMPLE 2

### Laboratory Indication of Cure Speed with HFCS

The following binder compositions were prepared by combining a nitrogen containing reactant and a reducing sugar reactant

| Binder | | % dry | |
|---|---|---|---|
| composition | nitrogen containing reactant | weight | Notes |
| 1a | AMOD (4-(aminomethyl)-1, | 22.5% | a TPTA |
| | 8-octanediamine | | triprimary |
| | | | triamine |
| 1b | TAPA (tris(3-aminopropyl)amine) | 24.0% | a triprimary |
| | | | tetramine |
| 1c | TAEA (tris(2-aminoethyl)amine) | 19.7% | a triprimary |
| | | | tetramine |

The nitrogen containing reactants of binder compositions 1b and 1c are not TPTA triprimary triamines and thus provide comparative examples. Each of the binder compositions was prepared by combining the nitrogen containing reactant with HFCS 42 (high fructose corn syrup with 42% fructose+52% dextrose+trace quantities of other saccharides) in water to obtain a solution/dispersion containing 1 molar equivalent of triprimary polyamine to 3.31 molar equivalents of reducing sugars. The amounts of triprimary polyamines used in the binder compositions are expressed above and in FIG. 8 as dry weight % (the remaining dry weight being the HFCS 42) and the binder compositions were prepared at 22.5% total solids weight. Each binder composition was formulated to give a primary amine to carbonyl molar ratio on 1:1.105. FIG. 8 shows the light absorbance of leachates from glass fiber filters: drops of the binder compositions were applied to the glass fiber filters which were then were placed in an oven at 107° C. and subsequently removed after set time intervals. Brown polymers were formed on the filters, then dissolved in water and the absorbance of the leachate measured using a spectrophotometer. The evolution of the formation of soluble brown polymers and insoluble polymers provides an initial laboratory indication of curing and cure speed for these type of binders.

FIG. 8 shows that binder composition 1a using AMOD (4-(aminomethyl)-1,8-octanediamine, a TPTA triprimary triamine) shows a faster curing rate compared to binder composition 1b using TAPA (tris(3-aminopropyl)amine) and binder composition 1c using TAEA (tris(2-aminoethyl)amine) which are both triprimary tetramines.

### EXAMPLE 3

### Particle Board

Single layer particleboard were prepared using AMOD (4-(aminomethyl)-1,8-octanediamine) or TAEA (tris(2-aminoethyl)amine)) as the sole nitrogen-containing reactant in a binder composition using a mixture of glucose and fructose as the reducing sugar reactant. The amounts of the reactants used in the binder compositions are expressed in Table 5 as dry weight % and the binder compositions were prepared at 70% total solids weight. The binder compositions were formulated to obtain a solution/dispersion containing 1 molar equivalent of triprimary polyamine to 2.25 molar equivalent of reducing sugars (primary amine to carbonyl mole ratio of 1:0.75). The boards (300×300×10 mm, 7.5% binder loading) were pressed (504 N at 195° C.) for 90 seconds, 100 seconds and 120 seconds). The internal bond strength (IB) was tested in accordance with EN 319:1993; the swelling test was performed in accordance with EN 317:1993.

For the press time of 90 s, the board made using TAEA as the nitrogen-containing reactant developed a blow crack when released from the press (see FIG. 9); this type of defect is typically caused by insufficient cure of the binder composition. However, the board prepared using AMOD as the nitrogen-containing reactant had sufficiently cured at a time press of 90 s and did not form a blow crack (see FIG. 10) when released from the press.

TABLE 5

| | Press | | Swelling |
|---|---|---|---|
| | Time | IB | (after |
| Binder composition (% dry weight) | (sec) | (N/mm²) | 24 hours) |
| 35% Glu + 35% Fru + 30% AMOD | 100 | 1.22 | 30.4% |
| 36.7% Glu + 36.7% Fru + 26.6% TAEA | 100 | 0.92 | 37.7% |
| 35% Glu + 35% Fru + 30% AMOD | 120 | 1.20 | 29.7% |
| 36.7% Glu + 36.7% Fru + 26.6% TAEA | 120 | 0.99 | 37.3% |

Key:
Glu = glucose;
Fru = fructose;
AMOD = 4-(aminomethyl)-1,8-octanediamine;
TAEA = tris(2-aminoethyl)amine

The results show that the boards made with the binder composition with AMOD also gave a higher average IB than the boards made with the binder composition with TAEA (results based on the average of 8 tested 5 cm×5 cm×1 cm blocks). The binder composition with AMOD gave better swelling results than the binder composition with TAEA.

The subsequent examples further demonstrate advantages of TPTA triprimary triamines in laboratory tests which can be extrapolated to manufacture of wood boards.

### EXAMPLE 4

Examples of binder compositions tested on mineral fiber veils are shown in Table 6 with their respective mean dry veil tensile strengths and mean wet tensile strengths.

In each case, a nitrogen containing reactant comprising a triprimary polyamine was combined with HFCS 42 (high fructose corn syrup with 42% fructose+52% dextrose+trace quantities of other saccharides) in water to obtain a solution/dispersion containing 1 molar equivalent of triprimary polyamine to 3.31 molar equivalent of reducing sugars. The amounts of triprimary polyamines used in the binder compositions are expressed in Table 6 as dry weight %, the remaining dry weight being the HFCS, and the binder compositions were prepared at 2% weight (bake out solids). Once the binder compositions were prepared, they were applied to A4 size glass veil and the glass veils were cured to obtain a quantity of cured binder in the final product of 10% LOI (loss on ignition).

Measurement of dry glass veil tensile strength:

8 pieces of cured glass veil with a dimension of 14.8 cm×5.2 cm were cut from the cured A4 size veil and subjected to tensile testing by attaching a 50 Kg load cell using glass veil tensile plates on a testometric machine (TESTOMETRIC M350-10CT). The average of the total force in Newtons of the breaking strength is given in the table below. For the measurement of wet glass veil tensile strength, the veil samples are tested wet after being immersed in water at 80° C. for 10 minutes.

The column of wet strength % gives the % of mean wet tensile strength with respect to the % mean dry tensile strength.

TABLE 6

| | Mean | Mean | |
|---|---|---|---|
| Triprimary polyamine | dry tensile | wet tensile | Wet |
| (% dry weight) | strength (N) | strength (N) | strength % |
| TAEA (19.7%) | 73.5 | 25.3 | 31.7% |
| TAPA (24.0%) | 80.9 | 31.4 | 38.8% |
| AMOD (22.5%) | 75.3 | 41.4 | 55.0% |

The results show that all the triprimary polyamines give good dry tensile strengths with TAPA giving a slightly better dry tensile strength compared to AMOD and TAEA. In regard of the wet tensile strengths, AMOD show better results compared to TAPA and TAEA. It is unexpected that the wet strength for AMOD was 55% of the value of the dry tensile strength while for TAPA it was only of 38.8%.

### EXAMPLE 5

Examples of binder composition tested on mineral fiber veils are shown in Table 7 with the respective mean dry veil tensile strengths:

In each test, the nitrogen-containing reactant(s) were mixed with glucose in water. The amounts of the reactants used in the binder compositions are expressed in Table 7 as dry weight % and the binder compositions were prepared at 2% solids weight (bake out solids). Once the binder compositions were prepared, they were applied to glass veil which were cured to obtain a quantity of cured binder in the cured veil of 10% LOI (loss on ignition).

The dry tensile strength is measured in the same way as described in example 4.

TABLE 7

| | | Mean |
|---|---|---|
| | | dry tensile |
| Test Ref | Binder composition (% dry weight) | strength (N) |
| G (comparative) | 85% Glu + 15% DAP | 76.5 |
| H (comparative) | 85% Glu + 15% AS | 73.5 |
| I (comparative) | 85% Glu + 15% TriCA | 93.0 |
| J | 85% Glu + 15% AMOD | 81.0 |
| K | 85% Glu + 5% AMOD + 10% DAP | 80.0 |
| L | 85% Glu + 7.5% AMOD + 7.5% DAP | 80.2 |
| M | 85% Glu + 10% AMOD + 5% DAP | 82.4 |
| N | 85% Glu + 5% AMOD + 10% AS | 84.7 |
| O | 85% Glu + 7.5% AMOD + 7.5% AS | 90.0 |
| P | 85% Glu + 10% AMOD + 5% AS | 88.6 |
| Q | 85% Glu + 5% AMOD + 10% TriCa | 88.0 |
| R | 85% Glu + 7.5% AMOD + 7.5% TriCA | 91.4 |
| S | 85% Glu + 10% AMOD + 5% TriCA | 87.9 |

Key:
Glu = glucose;
AS = ammonium sulphate;
DAP = diammonium phosphate;
TriCA = triammonium citrate;
AMOD = 4-(aminomethyl)-1,8-octanediamine

Binder compositions G, H and I are comparative examples of binder compositions with respectively only diammonium phosphate (DAP), ammonium sulfate (AS), and triammonium citrate (TriCa) as nitrogen-containing reactant. Binder composition J is a binder composition wherein the nitrogen-containing reactant consists of AMOD.

In examples K, L and M, the nitrogen-containing reactants consist of AMOD and DAP in different proportions. Examples J, K, L and M shows that similar levels of dry tensile strength are achieved for each of these binder compositions.

In examples N, O and P, the nitrogen-containing reactants consist of AMOD and AS in different proportions. The binder compositions N, O and P present higher dry tensile strengths compared to the result obtained with the binder composition J. Binder composition O seems to present an optimum result compared to binder compositions N and P. It is believed that there is a synergistic effect of the presence of AS and AMOD as the nitrogen-containing reactants.

FIG. 11 illustrates a TPTA triprimary triamine having three primary amines A, B, D with spacer groups which consist of carbon chains between each of its three primary amines. Each carbon atom is numbered to facilitate the explanation below.

The spacer group between primary amines A and B:
has a spacer length of 7, ie carbon atoms 1, 2, 3, 4, 5, 6, 7 which together form the shortest chain of covalently bonded polyvalent atoms between primary amines A and B (the carbon atoms of the two branched chains 8, 9 and 10, 11 do not form part of the spacer length;
has 11 polyvalent atoms, ie carbon atoms 1, 2, 3, 4, 5, 6, 7, 8, 9, 10 and 11 (the carbon atoms 12, 13, 14, 15, 16 do not form part of the spacer group between A and B as they form a chain which connects the third primary amine D to the molecule).

The spacer group between primary amines A and D:
has a spacer length of 10, ie carbon atoms 1, 2, 3, 4, 5, 12, 13, 14, 15, 16;
has 14 polyvalent atoms, ie carbon atoms 1, 2, 3, 4, 5, 8, 9, 10, 11, 12, 13, 14, 15, 16.

The spacer group between primary amines B and D:
has a spacer length of 8, ie carbon atoms 7, 6, 5, 12, 13, 14, 15, 16;
has 10 polyvalent atoms, ie carbon atoms 7, 6, 5, 12, 13, 14, 15, 16, 10, 11 (the chain of carbon atoms 4, 3, 2, 1, 8, 9 does not form part of the spacer group between B and D as this form a chain which connects the other primary amine A to the molecule.

The total number of polyvalent atoms in the molecule is 19, i.e. carbon atoms 1 to 16 and the 3 nitrogen atoms of the 3 primary amines A, B and D.

1. A method of manufacturing a wood particle board, comprising:
applying a binder composition, in the form of an aqueous solution, to loose wood matter to provide resinated loose wood matter, wherein the binder composition consists of a binder composition prepared by combining reactants comprising at least 50% by dry weight reducing sugar reactant(s) and at least 5% by dry weight nitrogen-containing reactant(s); and
arranging the resinated wood matter as a sheet of loosely arranged resinated wood matter; and
subjecting the sheet of loosely arranged resinated wood matter to heat and pressure to cure the binder composition and to form the wood board from the sheet of loosely arranged resinated wood;
wherein the nitrogen-containing reactant(s) comprise TPTA triprimary triamine(s), notably wherein the nitrogen-containing reactant(s) comprise at least 5% by dry weight of TPTA triprimary triamine(s), the TPTA triprimary triamine(s) being organic compound(s) having three and only three amines, each of the amines being primary amines or salts thereof, selected from:
a) triprimary triamine(s) having spacer groups between each of the three primary amines which consist of carbon chains;
b) triprimary triamine(s) having spacer groups between each of the three primary amines wherein each spacer group has a spacer length which is less than or equal to 12 polyvalent atoms; and
c) triprimary triamine(s) having a total number of polyvalent atoms which is less than or equal to 23.

2. A method according to claim 1, wherein the reducing sugar reactant(s) comprise reducing sugar reactant(s) selected from the group consisting of xylose, dextrose, fructose and combinations thereof.

3. A method according to claim 1, wherein the TPTA triprimary triamine(s) consist of triprimary triamine(s) having spacer groups between each of the three primary amines which consist of carbon chains.

4. A method according to claim 1, wherein the nitrogen-containing reactant(s) comprise triprimary triamine(s) selected from the group consisting of triaminodecanes, triaminononanes, triaminooctanes, triaminoheptanes, triaminohexanes, triaminopentanes, and combinations thereof.

5. A method according to claim 1, wherein the nitrogen-containing reactant(s) comprise 4-(aminomethyl)-1,8-octanediamine.

6. A method according to claim 1, wherein the binder composition consists of a binder composition prepared by combining reactants consisting of between 60% and 95% by dry weight reducing sugar reactant(s) and between 5% and 40% by dry weight nitrogen-containing reactant(s).

7. A method according to claim 1, wherein the nitrogen-containing reactant(s) comprise at least 95 wt % of TPTA triprimary triamine(s).

8. A method according to claim 1, wherein the nitrogen-containing reactants comprise reactant(s) different from the TPTA triprimary triamine(s), wherein the nitrogen-containing reactants comprise polyprimary polyamine(s), diprimary diamine(s), diprimary diamines selected from the group consisting of 1,6-diaminohexane, 1,5-diamino-2-methylpentane, and combinations thereof.

9. A method according to claim 1, wherein the nitrogen-containing reactants comprise reactant(s) different from the TPTA triprimary triamine(s), wherein the nitrogen-containing reactants comprise inorganic or organic ammonium salt selected from the group consisting of ammonium sulfate, ammonium phosphate, ammonium citrate, and combinations thereof.

10. A method according to claim 1, wherein the binder composition is applied to the loose wood matter in the form of an aqueous solution which comprises 40 to 95 wt %, 45 to 90 wt %, 50 to 85 wt %, or 55 to 80 wt % of solids, based on the total weight of the aqueous binder composition.

11. A method according to claim 1, wherein the binder composition is applied to the loose wood matter in the form of an aqueous solution which is prepared by combining all the reducing sugar reactant(s) and all the nitrogen-containing reactant(s) in a single preparation step.

12. A method according to claim 1, wherein the binder composition is applied to the loose wood matter in the form of an aqueous solution which is prepared by
combining all of the reducing sugar reactant(s), with a first portion of the nitrogen-containing reactant(s) to provide an intermediate binder composition comprising reaction products of the reducing sugar reactant(s) and the first portion of the nitrogen-containing reactant(s),
storing the intermediate binder composition; and
combining the intermediate binder composition with a second portion of the nitrogen-containing reactant(s) to provide the binder composition.

13. A method according to claim 1, wherein, in the form in which it is applied to the wood matter, the binder composition consists essentially of curable reaction product(s) of the reducing sugar reactant(s) and the nitrogen-containing reactant(s).

14. A wood board produced in accordance with the method of claim 1.

5. A wood board comprising wood matter held together by a cured thermoset binder, wherein the thermoset binder composition comprises a polymeric product of reducing sugar reactant(s) and nitrogen-containing reactant(s) and wherein the nitrogen-containing reactant(s) comprise triprimary triamine(s), the triprimary triamine(s) being organic compound(s) having three and only three amines, each of the amines being primary amines or salts thereof, having spacer groups between each of the three primary amines which consist of carbon chains, wherein the nitrogen-containing reactant(s) consist of 4-(aminomethyl)-1,8-octanediamine.
